(19) United States
(12) Patent Application Publication
(10) Pub. No.: US 2006/0221810 A1
(43) Pub. Date: Oct. 5, 2006

(54) Fine timing acquisition

(76) Inventors: Bojan Vrcelj, San Diego, CA (US); Fuyun Ling, San Diego, CA (US); Raghuraman Krishnamoorthi, San Diego, CA (US); Vinay Murthy, San Diego, CA (US)

Correspondence Address: QUALCOMM INCORPORATED, 5775 MOREHOUSE DR., SAN DIEGO, CA, 92121, US

(21) Appl. No.: 11/372,394

(22) Filed: Mar. 8, 2006

Related U.S. Application Data
(60) Provisional application No. 60/660,901, filed on Mar. 10, 2005.

(51) Int. Cl. H04J 11/00; H04J 3/06

(52) U.S. Cl. 370/208; 370/503

(57) ABSTRACT

A method for synchronizing timing of a receiver to a received orthogonal frequency division multiplexing (OFDM) signal is disclosed. A first timing acquisition is performed with a first received time division multiplexed (TDM) pilot to determine a course timing estimate of the received OFDM signal. A second timing acquisition is performed with a second TDM pilot to determine a fine timing estimate for a OFDM symbol of the received OFDM signal. In the second timing acquisition, the accumulated energy of channel taps over a detection window is determined and a trailing edge of the accumulated energy curve is detected. A Fourier transform (FT) collection window location for subsequent OFDM symbols is adjusted according to the trailing edge information.

### CLAIM OF PRIORITY UNDER 35 U.S.C. §119

The present Application for Patent claims priority to Provisional Application No. 60/660,901, filed Mar. 10, 2005, and assigned to the assignee hereof and hereby expressly incorporated by reference herein.

### BACKGROUND

The present invention relates generally to data communication, and more specifically to synchronization in a information transport system using orthogonal frequency division multiplexing (OFDM).

In an OFDM system, a transmitter processes data to obtain modulation symbols, and further performs modulation on the modulation symbols to generate OFDM symbols. The transmitter then conditions and transmits the OFDM symbols via a communication channel. The OFDM system may use a transmission structure whereby data is transmitted in super-frames, with each super-frame having a time duration. Different types of data (e.g., traffic/packet data, overhead/control data, pilot, and so on) may be sent in different parts of each super-frame. Each super-frame may be divided into a number of frames. The term “pilot” generically refers to data and/or transmission that are known in advance by both the transmitter and a receiver.

The receiver typically needs to obtain accurate frame and symbol timing in order to properly recover the data sent by the transmitter. For example, the receiver may need to know the start of each super-frame and frame in order to properly recover the different types of data sent in the super-frame. The receiver often does not know the time at which each OFDM symbol is sent by the transmitter nor the propagation delay introduced by the communication channel. The receiver would then need to ascertain the timing of each OFDM symbol received via the communication channel in order to properly perform the complementary OFDM demodulation on the received OFDM symbol.

The term synchronization in this disclosure refers to a process performed by the receiver to obtain frame and symbol timing. The receiver may also perform other tasks, such as frequency error estimation and channel estimation. Synchronization can occur at different times to improve timing and correct for changes in the channel. Quickly performing synchronization eases acquisition of the signal.

### SUMMARY

In an aspect, the present disclosure provides a method for synchronizing timing of a receiver to a received orthogonal frequency division multiplexing (OFDM) signal. In one step, a first timing acquisition is performed with a first received time division multiplexed (TDM) pilot to determine a course timing estimate of the received OFDM signal. A second timing acquisition is performed with a second TDM pilot to determine a fine timing estimate for a OFDM symbol of the received OFDM signal. In the second timing acquisition, the accumulated energy of channel taps over a detection window is determined and a trailing edge of the accumulated energy curve is detected. In an alternative embodiment, one or both of the leading and trailing edges can be determined in the second timing acquisition. A Fourier transform (FT) collection window location is adjusted for a subsequent OFDM symbol according to the second timing acquisition step.

In an aspect, an OFDM system for synchronizing timing of a receiver to a received OFDM signal is disclosed. The OFDM system includes means for performing a first timing acquisition, means for performing a second timing acquisition and means for adjusting a DFT collection window location. The means for performing a first timing acquisition with a first received TDM pilot determines a course timing estimate of the received OFDM signal. The means for performing a second timing acquisition with a second TDM pilot determines a fine timing estimate for the received OFDM signal. The means for performing the second timing acquisition includes means for determining and means for detecting. The means for determining accumulated energy of a plurality of channel taps within a detection window for a plurality of starting locations forms an accumulated energy curve. The means for detecting finds a trailing edge of the accumulated energy curve. The means for adjusting a FT collection window location for a subsequent OFDM symbol is done according to an outcome from the means for performing the second timing acquisition.

In an aspect, a method for synchronizing timing of a receiver to a received signal. In one step, a first timing acquisition is performed to determine a course timing estimate of the received signal. A second timing acquisition is performed with a TDM pilot to determine a fine timing estimate for a symbol of the received signal The second timing acquisition determines accumulated energy of a plurality of channel taps within a detection window for a plurality of starting locations to form an accumulated energy curve. Additionally, the second timing acquisition detects a trailing edge of the accumulated energy curve. The determining accumulated energy and the detecting the trailing edge are performed, at least partially, co-incident in time for a particular channel tap of the plurality of channel taps. A FT collection window location is adjusted for a subsequent symbol according to the performing the second timing acquisition step.

In an aspect, a communication device for synchronizing timing of a receiver to a received signal is disclosed. The communication device includes a processor and a memory that are coupled together. The processor is configured to cause performing of at least the following steps:

1. Performing a first timing acquisition with a first received time division multiplexed (TDM) pilot to determine a course timing estimate of the received OFDM signal.

2. Performing a second timing acquisition with a second TDM pilot to determine a fine timing estimate of the received OFDM signal. The performing the second timing acquisition step comprises sub-steps of determining accumulated energy of a plurality of channel taps within a detection window for a plurality of starting locations to form an accumulated energy curve, and detecting a trailing edge of the accumulated energy curve.

3. Adjustment of a Fourier transform (FT) collection window location for a subsequent OFDM symbol according to the performing the second timing acquisition step.

### BRIEF DESCRIPTION OF THE DRAWINGS

The present disclosure is described in conjunction with the appended figures:

FIG. 1 is a block diagram of an embodiment of a base station and a wireless receiver in an orthogonal frequency division multiplexing (OFDM) system;

FIGS. 2A and 2B are block diagrams of embodiments of a super-frame structure for the OFDM system;

FIG. 3 is a diagram of an embodiment of a frequency-domain representation of a time division multiplexed (TDM) pilot 2;

FIG. 4 is a block diagram of an embodiment of a transmit (TX) data and pilot processor;

FIG. 5 is a block diagram of an embodiment of an OFDM modulator;

FIG. 6 is a diagram of an embodiment of a time-domain representation of a TDM pilot 2;

FIG. 7 is a block diagram of an embodiment of a synchronization and channel estimation unit;

FIG. 8 is a diagram of an embodiments of the timeline of operations used for fine timing acquisition (FTA);

FIG. 9 is a block diagram of an embodiment of a symbol timing detector;

FIGS. 10A to 10D are diagrams that show processing for a pilot-2 OFDM symbol;

FIG. 11 is a diagram of an embodiment of a pilot transmission scheme with TDM and FDM pilots;

FIG. 12 is a block diagram of an embodiment of logic for removing the modulation of pilot symbols;

FIG. 13 is a block diagram of an embodiment of an implementation of a norm operation for timing synchronization;

FIG. 14 is a block diagram of an embodiment of a fixed point implementation of a first phase of FAP detection in a FTA;

FIG. 15 is a flow diagram of an embodiment of a process for showing three phases for a FAP detection algorithm;

FIG. 16 is a block diagram of an embodiment of an update step in phase three of FAP detection;

FIG. 17 is a block diagram of an embodiment for initializing the data mode time tracking (DMTT);

FIG. 18 is a block diagram of an embodiment an OFDM system for synchronizing timing of a receiver to a received OFDM signal; and

FIG. 19 is a flow chart of an embodiment of a process for synchronizing timing of a receiver to a received OFDM signal.

In the appended figures, similar components and/or features may have the same reference label.

### DETAILED DESCRIPTION

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It is understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The synchronization techniques described herein may be used for various multi-carrier systems and for the downlink as well as the uplink. The downlink (or forward link) refers to the communication link from the base stations to the wireless receivers, and the uplink (or reverse link) refers to the communication link from the wireless receivers to the base stations. For clarity, these techniques are described below for the downlink in an orthogonal frequency division multiplexing (OFDM) system. The pilot detection structure is well suited for a broadcast system but may also be used for non-broadcast systems.

An improved method and system for timing synchronization after the initial acquisition in an OFDM system are disclosed. The result of the initial timing acquisition, based on time division multiplexed (TDM) pilot 1 processing, is a coarse timing estimate. The course timing estimate provides the information about the beginning of a super-frame, and gives a coarse estimate of the beginning of the TDM pilot 2. With further timing estimation using the TDM pilot 2 structure, the receiver estimates the exact starting position of the subsequent OFDM symbols. This step is called fine timing acquisition (FTA). A side product of this computation is a channel estimate which can be used to initialize the channel estimation block.

This algorithm is designed to successfully handle the channels with delay spreads of up to 1024 chips or samples in one embodiment. Inaccuracies of the initial coarse timing estimates are corrected such that coarse timing errors anywhere between −K and +1024−K chips are corrected-in one embodiment. In another embodiment, the errors between −256 and +768 chips can be corrected. The FTA processing is designed in such way that the timing corrections are available by the time they need to be applied. In other words, the FTA is completed before the next symbol is received.

In one embodiment, TDM pilot 2 symbol includes a cyclic prefix followed by two identical pilot-2 sequences in the time domain. The receiver collects at least N_{C}=N/2 or 2048 samples in a sample window from a position that is determined based on the coarse timing and the initial deliberate offset introduced to avoid collecting data from neighboring symbols, where N could have different values in different embodiments. The 2048 samples correspond to a cyclic shift of one TDM pilot 2 sequence period, convolved with the channel. After a L-point FFT, a pilot demodulation and an IFFT, what remains is a cyclic shift of the channel impulse response.

Next, the beginning of the channel impulse response in this 2048-long cyclically-shifted image is determined. The complete channel energy is contained within a detection window of length 1024. If the channel is shorter than 1024 chips, there are several consecutive positions of the energy window that result in maximum energy. In this case, the algorithm picks the last position of an accumulated energy curve, since this generally corresponds to first arriving path (FAP) of the channel. This is achieved by considering a convex combination of the running energy sum and a local finite difference of order N_{D}. Once the location of the FAP is located in the 2048-long shifted channel estimate, this information is readily converted to a timing offset that is applied when sampling the subsequent OFDM symbols.

Another product of this algorithm is a 1024-long time domain channel estimate. The block for channel estimation uses three consecutive 512-long time domain channel estimates and combines them inside time-filtering operation in order to produce a 1024-long channel estimate resistant to timing variations. We use the 1024-long, “clean” or filtered channel estimate obtained during the FTA in order to initialize the channel estimation block. This is done by aliasing it to a 512-long version, compatible with the channel estimation block. This is then used to produce a valid channel estimate for the first symbol of interest.

The accuracy in timing synchronization is achieved by tying it to the channel estimates and incorporating both an accumulated energy curve and its first derivative in detecting the FAP. At the same time, this results in robustness of this method to excess delay spreads. The repetitive structure of the TDM pilot 2 produces the cyclic shifts of the channel estimates. There is a simple one-to-one correspondence between these cyclic shifts and timing offsets. The structure of TDM pilot 2 symbol and the initial offsets that are deliberately introduced make the system more robust to the errors of coarse timing acquisition estimates. Finally, the novel architecture of the FTA operation in a symbol timing searcher block, and its intermesh to the IFFT block, makes it computationally efficient and allows for the stringent computational time requirements to be met in one embodiment.

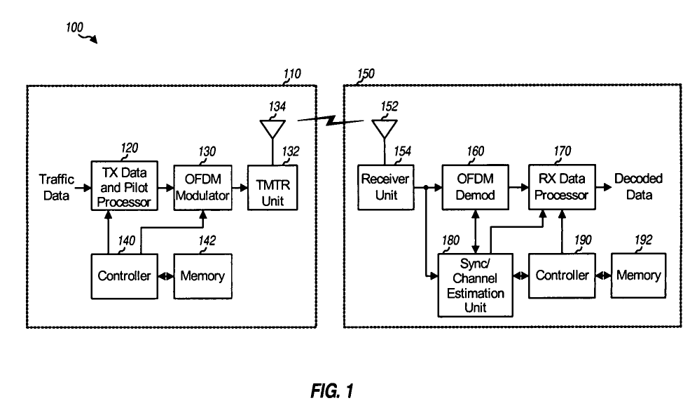

Referring first to FIG. 1, a block diagram of an embodiment of a base station 110 and a wireless receiver 150 in an OFDM system 100 is shown. The base station 110 is generally a fixed station and may also be referred to as a base transceiver system (BTS), an access point, or by some other term. Wireless receiver 150 may be fixed or mobile and may also be referred to as a user terminal, a mobile station, or by some other term. The wireless receiver 150 may also be a portable unit such as a cellular phone, a handheld device, a wireless module, a personal digital assistant (PDA), a television receiver, and so on.

At the base station 110, a TX data and pilot processor 120 receives different types of data (e.g., traffic/packet data and overhead/control data) and processes (e.g., encodes, interleaves, and symbol maps) the received data to generate data symbols. As used herein, a “data symbol” is a modulation symbol for data, a “pilot symbol” is a modulation symbol for a pilot, and a modulation symbol is a complex value for a point in a signal constellation for a modulation scheme (e.g., M-PSK, M-QAM, and so on). The pilot processor 120 also processes pilot data to generate pilot symbols and provides the data and pilot symbols to an OFDM modulator 130.

OFDM modulator 130 multiplexes the data and pilot symbols onto the proper subbands and symbol periods and further performs OFDM modulation on the multiplexed symbols to generate OFDM symbols, as described below. A transmitter (TMTR) unit 132 converts the OFDM symbols into one or more analog signals and further conditions (e.g., amplifies, filters, frequency upconverts, etc.) the analog signal(s) to generate a modulated signal. Base station 110 then transmits the modulated signal from an antenna 134 to wireless receivers in the OFDM system 100.

At the wireless receiver 150, the transmitted signal from base station 110 is received by an antenna 152 and provided to a receiver unit 154. The receiver unit 154 conditions (e.g., filters, amplifies, frequency downconverts, etc.) the received signal and digitizes the conditioned signal to obtain a stream of input samples. An OFDM demodulator 160 performs OFDM demodulation on the input samples to obtain received data and pilot symbols. OFDM demodulator 160 also performs detection (e.g., matched filtering) on the received data symbols with a channel estimate (e.g., a frequency response estimate) to obtain detected data symbols, which are estimates of the data symbols sent by base station 110. OFDM demodulator 160 provides the detected data symbols to a receive (RX) data processor 170.

A synchronization/channel estimation unit (SCEU) 180 receives the input samples from receiver unit 154 and performs synchronization to determine frame and symbol timing, as described below. The SCEU 180 also derives the channel estimate using received pilot symbols from OFDM demodulator 160. The SCEU 180 provides the symbol timing and channel estimate to OFDM demodulator 160 and may provide the frame timing to RX data processor 170 and/or a controller 190. The OFDM demodulator 160 uses the symbol timing to perform OFDM demodulation and uses the channel estimate to perform detection on the received data symbols.

RX data processor 170 processes (e.g., symbol demaps, deinterleaves, decodes, etc.) the detected data symbols from OFDM demodulator 160 and provides decoded data. RX data processor 170 and/or controller 190 may use the frame timing to recover different types of data sent by base station 110. In general, the processing by OFDM demodulator 160 and RX data processor 170 is complementary to the processing by OFDM modulator 130 and TX data and pilot processor 120, respectively, at base station 110.

Controllers 140, 190 direct operation at base station 110 and wireless receiver 150, respectively. The controllers could be processors and/or state machines. Memory units 142, 192 provide storage for program codes and data used by controllers 140 and 190, respectively. The memory units 142, 192 could use various types of storage medium to store information.

The base station 110 may send a point-to-point transmission to a single wireless receiver, a multi-cast transmission to a group of wireless receivers, a broadcast transmission to all wireless receivers under its coverage area, or any combination thereof. For example, base station 110 may broadcast pilot and overhead/control data to all wireless receivers under its coverage area. Base station 110 may further single-cast transmit user-specific data to specific wireless receivers, multi-cast data to a group of wireless receivers, and/or broadcast data to all wireless receivers in various situations and embodiments.

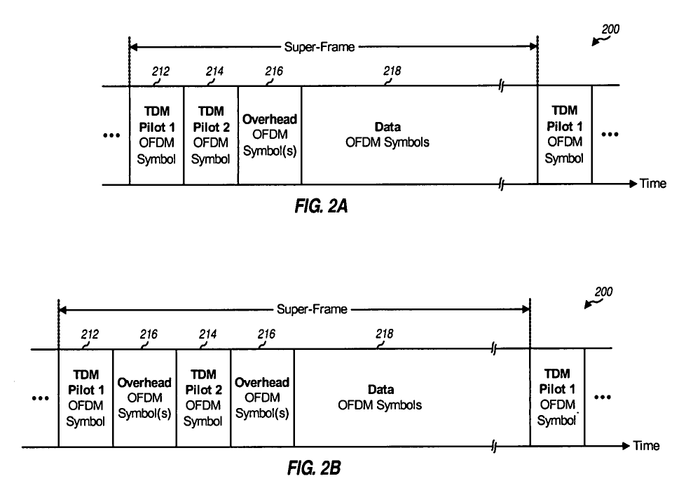

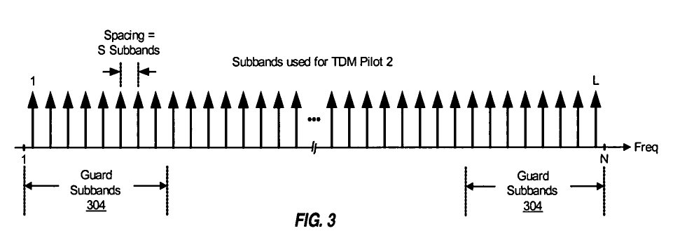

With reference to FIG. 2A, an embodiment of a super-frame structure 200 that may be used for OFDM system 100 is shown. Data and pilot may be transmitted in super-frames, with each super-frame having a predetermined time duration. A super-frame may also be referred to as a frame, a time slot, or some other terminology. In this embodiment, each super-frame includes a TDM pilot 1 field 212 for a first TDM pilot, a TDM pilot 2 field 214 for a second TDM pilot, an overhead field 216 for overhead/control data, and a data field 218 for traffic/packet data.

The four fields 212 through 218 are time division multiplexed in each super-frame such that only one field is transmitted at any given moment. The four fields are also arranged in the order shown in FIG. 2 to facilitate synchronization and data recovery. Pilot OFDM symbols in pilot fields 212 and 214, which are transmitted first in each super-frame, may be used for detection of overhead OFDM symbols in field 216, which is transmitted next in the super-frame. Overhead information obtained from field 216 may then be used for recovery of traffic/packet data sent in data field 218, which is transmitted last in the super-frame.

In an embodiment, TDM pilot 1 field 212 carries one OFDM symbol for TDM pilot 1, and TDM pilot 2 field 214 also carries one OFDM symbol for TDM pilot 2. In general, each field may be of any duration, and the fields may be arranged in any order. TDM pilots 1 and 2 are broadcast periodically in each super-frame to facilitate synchronization by the wireless receivers. Overhead field 216 and/or data field 218 may also contain pilot symbols that are frequency division multiplexed with data symbols, as described below.

The OFDM system 100 has an overall system bandwidth of BW MHz, which is partitioned into N orthogonal subbands using OFDM. The spacing between adjacent subbands is BW/N MHz. Of the N total subbands, M subbands may be used for pilot and data transmission, where M<N, and the remaining N−M subbands may be unused and serve as guard subbands. In an embodiment, the OFDM system uses an OFDM structure with N=4096 total subbands, M=4000 usable subbands, and N−M=96 guard subbands. In general, any OFDM structure with any number of total, usable, and guard subbands may be used for the OFDM system.

TDM pilots 1 and 2 may be designed to facilitate synchronization by the wireless receivers in the system. A wireless receiver may use TDM pilot 1 to detect the start of each super-frame, obtain a coarse estimate of symbol timing, and estimate frequency error. The wireless receiver may use TDM pilot 2 to obtain more accurate OFDM symbol timing.

With reference to FIG. 2B, another embodiment of a super-frame structure 200 that may be used for OFDM system 100 is shown. This embodiment follows TDM pilot-1 212 with TDM pilot-2 214, with overhead OFDM symbols 216 added in-between. The number and duration of overhead symbols are known such that synchronization to the TDM pilot-1 symbol 212 allows estimating where the TDM pilot-2 symbol will begin.

Referring next to FIG. 3, an embodiment of TDM pilot 2 214 is shown in the frequency domain. For this embodiment, TDM pilot 2 214 comprises L pilot symbols that are transmitted on L subbands. The L subbands are uniformly distributed across the N total subbands and are equally spaced apart by S subbands, where S=N/L. For example, N=4096, L=2048, and S=2. Again, other values may also be used for N, L, and S. This structure for TDM pilot 2 214 can provide accurate symbol timing in various types of channels including a severe multi-path channel. The wireless receivers 150 may also be able to: (1) process TDM pilot 2 214 in an efficient manner to obtain symbol timing prior to the arrival of the next OFDM symbol, which is right after TDM pilot 2 in one embodiment, and (2) apply the symbol timing to this next OFDM symbol, as described below. The L subbands for TDM pilot 2 are selected such S identical pilot-2 sequences are generated for TDM pilot 2 214.

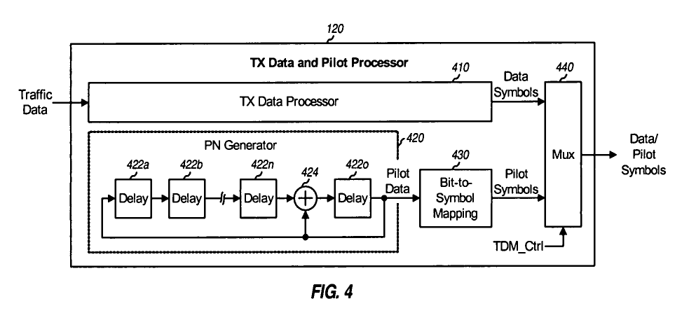

With reference to FIG. 4, one embodiment of a block diagram of an embodiment of TX data and pilot processor 120 of the base station 110 is shown. Within the pilot processor 120, a TX data processor 410 receives, encodes, interleaves, and symbol maps traffic/packet data to generate data symbols.

In an embodiment, a pseudo-random number (PN) generator 420 is used to generate data for the pilots 212, 214. The PN generator 420 may be implemented, for example, with a 15-tap linear feedback shift register (LFSR) that implements a generator polynomial g(x)=x¹⁵+x¹⁴+1. In this case, the PN generator 420 includes: (1) 15 delay elements 422a through 422o coupled in series, and (2) a summer 424 coupled between delay elements 422n and 422o. The delay element 422o provides pilot data, which is also fed back to the input of delay element 422a and to one input of summer 424. PN generator 420 may be initialized with different initial states for the pilots 212, 214, e.g., to ‘011010101001110’ for the TDM pilot 1, to ‘010110100011100’ for the TDM pilot 2 and to ‘010110101011101’ for the frequency division multiplexed (FDM) pilot. In general, any data may be used for the pilots 212, 214. The pilot data may be selected to reduce the difference between the peak amplitude and the average amplitude of a pilot OFDM symbol (i.e., to minimize the peak-to-average variation in the time-domain waveform for the TDM pilot). The pilot data for TDM pilot 2 may also be generated with the same PN generator used for scrambling data. The wireless receivers have knowledge of the data used for TDM pilot 2 but do not need to know the data used for TDM pilot 1.

A bit-to-symbol mapping unit 430 receives the pilot data from PN generator 420 and maps the bits of the pilot data to pilot symbols based on a modulation scheme. The same or different modulation schemes may be used for the pilots 212, 214. In an embodiment, QPSK is used for both TDM pilots 1 and 2. In this case, mapping unit 430 groups the pilot data into 2-bit binary values and further maps each 2-bit value to a specific pilot modulation symbol. Each pilot symbol is a complex value in a signal constellation for QPSK. If QPSK is used for the TDM pilots, then mapping unit 430 maps 2L₁ pilot data bits for TDM pilot 1 to L₁ pilot symbols and further maps 2L₂ pilot data bits for TDM pilot 2 to L₂ pilot symbols. A multiplexer (Mux) 440 receives the data symbols from TX data processor 410, the pilot symbols from mapping unit 430, and a TDM_Ctrl signal from controller 140. Multiplexer 440 provides to the OFDM modulator 130 the pilot symbols for the pilots 212, 214 and the data symbols for the overhead and data fields of each super-frame, as shown in FIGS. 2A and 2B.

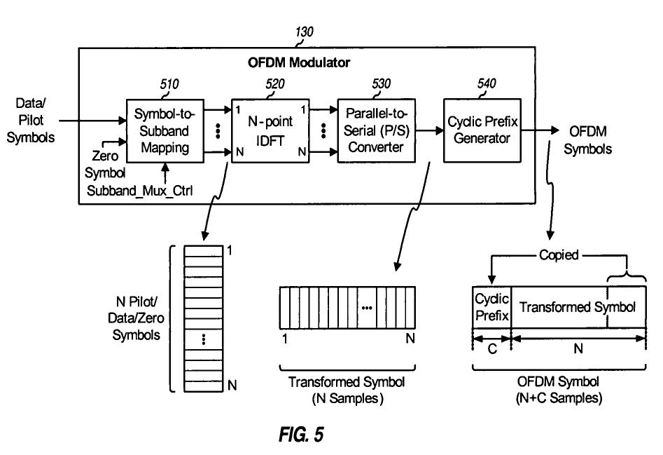

Referring next to FIG. 5, one embodiment of a block diagram of an embodiment of OFDM modulator 130 of the base station 110 is shown. A symbol-to-subband mapping unit 510 receives the data and pilot symbols from TX data and pilot processor 120 and maps these symbols onto the proper subbands based on a Subband_Mux_Ctrl signal from controller 140. In each OFDM symbol period, the mapping unit 510 provides one data or pilot symbol on each subband used for data or pilot transmission and a “zero symbol” (which is a signal value of zero) for each unused subband. The TDM pilot symbols 212, 214 designated for subbands that are not used are replaced with zero symbols. For each OFDM symbol period, mapping unit 510 provides N “transmit symbols” for the N total subbands, where each transmit symbol may be a data symbol, a pilot symbol, or a zero symbol.

An inverse discrete Fourier transform (IDFT) unit 520 receives the N transmit symbols for each OFDM symbol period, transforms the N transmit symbols to the time domain with an N-point IDFT, and provides a “transformed” OFDM symbol that contains N time-domain samples. Each sample is a complex value to be sent in one sample period. An N-point inverse fast Fourier transform (IFFT) may also be performed in place of an N-point IDFT if N is a power of two, which is typically the case.

A parallel-to-serial (P/S) converter 530 serializes the N samples for each transformed symbol. A cyclic prefix generator 540 then repeats a portion (or C samples) of each transformed symbol to form an OFDM symbol that contains N+C samples. For example, the cyclic prefix is the last 512 samples of the OFDM symbol. The cyclic prefix is used to combat inter-symbol interference (ISI) and intercarrier interference (ICI) caused by a long delay spread in the communication channel. Generally, delay spread is the time difference between the FAP and the latest arriving path (LAP) at a receiver 150. An OFDM symbol period (or simply, a “symbol period”) is the duration of one OFDM symbol and is equal to N+C sample periods.

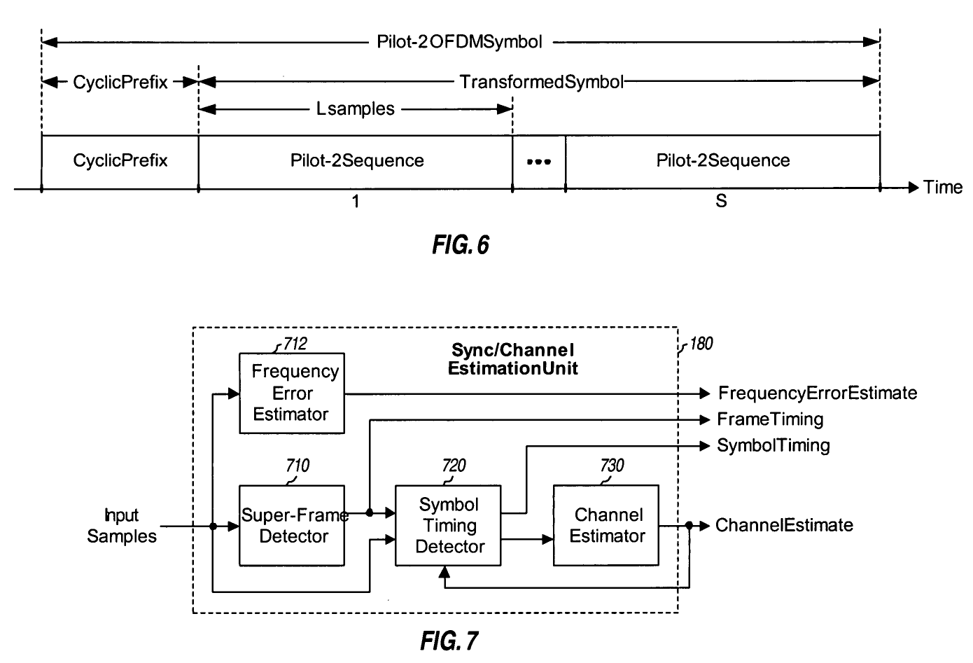

With reference to FIG. 6, one embodiment of a time-domain representation of TDM pilot 2 is shown. An OFDM symbol for TDM pilot 2 (or “pilot-2 OFDM symbol”) is also composed of a transformed symbol of length N and a cyclic prefix of length C. The transformed symbol for TDM pilot 2 contains S identical pilot-2 sequences, with each pilot-2 sequence containing L time-domain samples. The cyclic prefix for TDM pilot 2 is composed of the C rightmost samples of the transformed symbol and is inserted in front of the transformed symbol. For example, if N=4096, L=2048, S=2, and C=512, then the pilot-2 OFDM symbol would contain two complete pilot-2 sequences, with each pilot-2 sequence containing 2048 time-domain samples. The cyclic prefix for TDM pilot 2 would contain only a portion of the pilot-2 sequence.

Referring next to FIG. 7, one embodiment of a block diagram of the SCEU 180 at wireless receiver 150 is shown. Within the SCEU 180, a super-frame detector 710 receives the input samples from receiver unit 154, processes the input samples to detect for the start of each super-frame, and provides the super-frame timing. A symbol timing detector 720 receives the input samples and the super-frame timing, processes the input samples to detect for the start of the received OFDM symbols, and provides the symbol timing. A frequency error estimator 712 estimates the frequency error in the received OFDM symbols. A channel estimator 730 receives an output from symbol timing detector 720 and derives the channel estimate. The detectors and estimators in SCEU 180 are described below.

The super-frame detector 710 performs super-frame synchronization by detecting for TDM pilot 1 in the input samples from receiver unit 154. For this embodiment, the super-frame detector 710 is implemented with a delayed correlator that exploits the periodic nature of the pilot-1 OFDM symbol for super-frame detection.

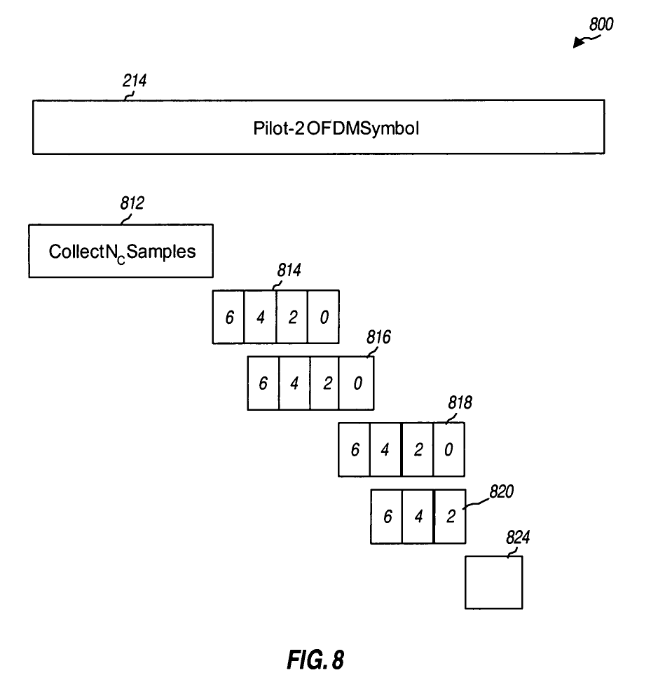

With reference to FIG. 8, a block diagram shows a timeline 800 for one embodiment of FTA. FAP detection, or channel location search is performed as the last stage of FTA. In the depicted portion of the process, a sample window of length N_{C} is gathered in block 812. Next, a N_{C}-point FFT is performed upon the sample window in block 814, where N_{C} is 2048 in this example. The FFT is done in a cascade of 512-point FFTs using the interlace sequence 6,4,2, and 0. The pilot information is demodulated and extrapolated from the subcarriers in block 816 in the same interlace sequence. A N_{C}-point IFFT is performed in block 818 on the demodulated pilot as a cascade of 512-point IFFTs using the same interlace sequence. A twiddle multiply on the 6, 4 and 2 interlaces begins after block 816 completes. The FTA search is initialized in block 820 to begin the process of finding the FAP. This pipelined process is further described below and allows faster fine timing acquisition.

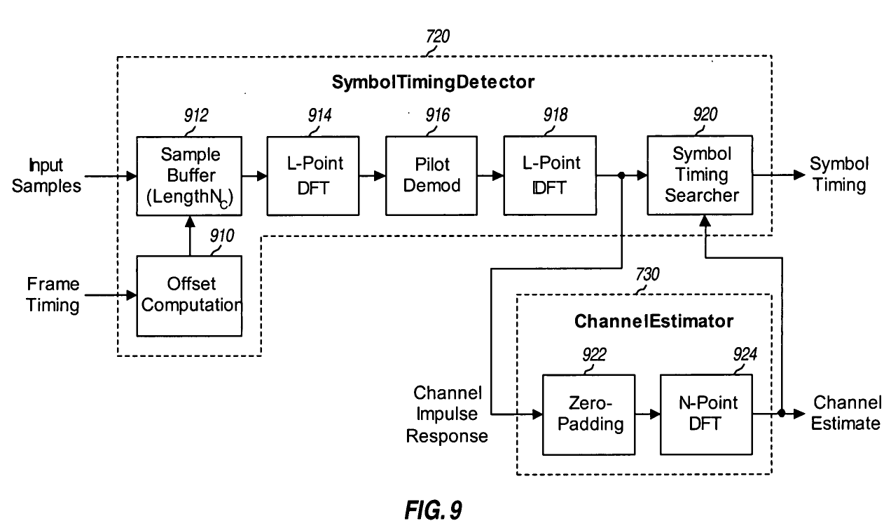

With reference to FIG. 9, a block diagram of an embodiment of symbol timing detector 720 is shown for one embodiment, which performs timing synchronization based on the pilot-2 OFDM symbol. Within symbol timing detector 720, a sample buffer 912 receives the input samples from receiver unit 154 and stores a “sample” window of L input samples for the pilot-2 OFDM symbol. The start of the sample window is determined by an offset computation unit 910 based on the super-frame timing from super-frame detector 710.

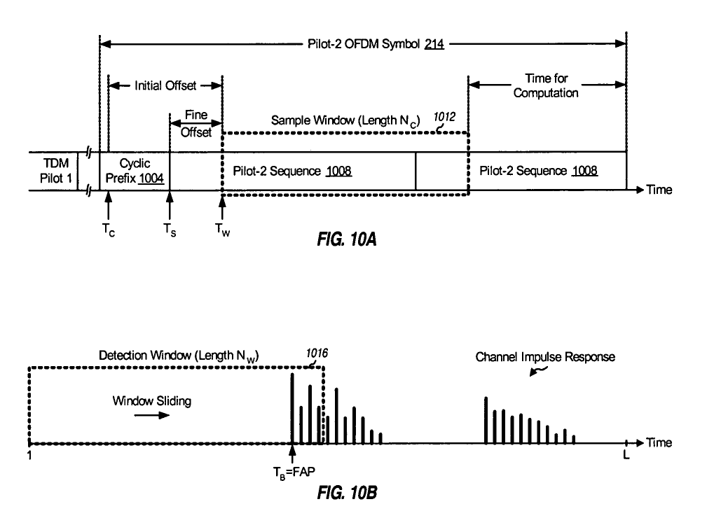

With reference to FIG. 10A, a timing diagram of the processing for the pilot-2 OFDM symbol is shown in one embodiment. Super-frame detector 710 provides the coarse symbol timing (denoted as T_{c}) based on the pilot-1 OFDM symbol even thought the pilot-1 is detected at some later point (denoted as T_{D}). The offset computation block 910 determines T_{W} to position the sample window 1012. The pilot-2 OFDM symbol contains S identical pilot-2 sequences where each has a length, L (e.g., two pilot-2 sequences of length 2048 if N=4096 and L=2048). A sample window 1012 of N_{C} input samples is collected by sample buffer 912 for the pilot-2 OFDM symbol starting at location T_{W}.

The start of the sample window 1012 is delayed by an initial offset OSᵢₙᵢₜ from the coarse symbol timing, T_{C}, or T_{W}=T_{C}+OSᵢₙᵢₜ. The initial offset does not need to be especially accurate and is selected to ensure that one complete pilot-2 sequence is collected in sample buffer 912 despite possible errors in the course timing estimate. The initial offset may also be selected to be small enough such that the processing for the pilot-2 OFDM symbol can be completed before the arrival of the next OFDM symbol, so that the symbol timing obtained from the pilot-2 OFDM symbol may be applied to this next OFDM symbol.

In this embodiment, the notion of the symbol boundaries is tracked by an OFDM sample counter. The OFDM sample counter assumes the value 0 at the beginning of the cyclic prefix of an OFDM symbol and counts up until value N_{OFDM}−1, where N_{OFDM} is the overall duration of an OFDM symbol, after which it rolls over back to zero. During the processing of regular OFDM symbols, the samples are being sent to the FFT engine 914 for demodulation after the OFDM sample counter reaches-value N_{CP}=C. The symbol timing corrections, determined by the symbol timing searcher 920, are applied by changing the current value of the OFDM sample counter by the amount corresponding to the computed timing offset. After coarse acquisition, at time T_{D}, the coarse notion of symbol boundary at the receiver is captured by writing the value T_{D}−T_{C} into the OFDM sample counter. The initial offset, OSᵢₙᵢₜ, is then applied in two steps. The OFDM sample counter value is first increased by K and decreased by the duration of the window between OFDM symbols (e.g., 17 in this embodiment) in the offset computation block 910. The constant K corresponds to the ability of the algorithm to correct coarse timing errors and in this embodiment, K=256. When the OFDM sample counter reaches a count of 1024 in this embodiment, the start of the sample period, T_{W}, is presumed and the sample window 1012 begins. Other embodiments could use other values for the first and second constants and the count.

Referring back to FIG. 9, a discreet Fourier transform (DFT) unit 914 performs an L-point DFT or FFT on the N_{C}=L input samples collected by sample buffer 912 and provides L frequency-domain values for the L received pilot symbols. If the start of the sample window 1012 is not aligned with the start of the pilot-2 OFDM symbol (i.e., T_{W}≠T_{S}), then the channel impulse response is circularly shifted, which means that a front portion of the channel impulse response wraps around to the back.

The pilot-2 OFDM symbol 214 has a cyclic prefix 1004 and two pilot-2 sequences 1008 in succession for this embodiment. In the frequency domain for one embodiment, the pilot-2 symbol 214 consists of 2000 non-zero QPSK subcarriers or subbands that are each separated by a zeroed subcarrier with guard subcarriers 304 on each end as shown in FIG. 3. Zero insertion between two non-zero subcarriers ensures that TDM pilot-2 consists of two periods of 2048 samples each in the time domain. At the receiver side, only 2048 or N_{C} samples of TDM pilot 2 are captured in the sample window 1012.

After the initial L-point FFT 914 has taken place, for L=2048, the initial 2000 non-zero carriers and 48 guard carriers are available, after passing through the channel. Non-zero carriers are modulated by the information on the channel, and the noise is added. In order to recover the channel information, i.e., estimate the channel impulse response up to 2048 taps, we need to “undo” the scrambling of the non-zero carriers and zero-out the carriers that have been omitted (i.e., guard carriers), before the L-point IFFT block 918. This operation is called TDM pilot-2 symbol demodulation and extrapolation, which is performed in the pilot demodulation unit 916.

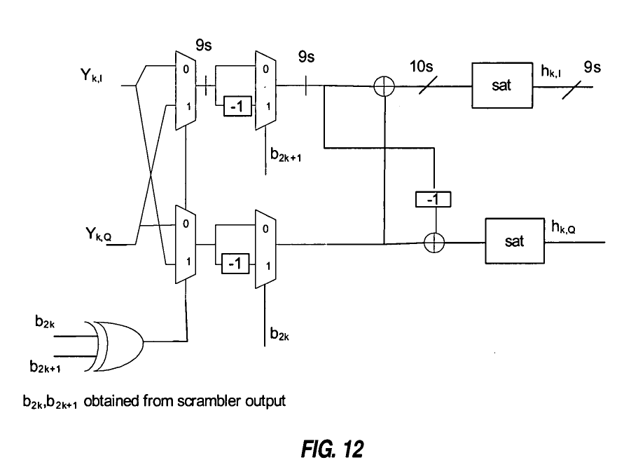

Referring next to FIG. 12, an embodiment of the pilot demodulation logic to implement the demodulation operation of the non-zero pilot sequence in any interlace is shown. In this embodiment, an interlace represents a subset of N_{I}, subcarriers which are uniformly spaced in the original set of N subcarriers. For example, N can be 4096 as in this embodiment, and if eight interlaces are used, each interlace I is a set of N_{I} subcarriers, which are separated by seven subcarriers which do not belong in interlace I. At the input to the demodulation block 916, the in-phase and the quadrature phase components of the pilot observations are each given by 9 signed bits, while after the demodulation, the bitwidth remains 9.

Referring back to FIG. 9, each output sample of the L-point FFT block 914 is a complex number where the real and the imaginary numbers are each 9 bit signed numbers in this embodiment. The removal of the pilot modulation is essentially a multiplication of each pilot carrier with the reference value corresponding to that subcarrier, which is made available at the receiver. This operation is performed four times with four different reference sequences, as four different interlaces (i.e., 6, 4, 2, and 0) are collected from the outputs of the FFT block 914. The pilot observation in interlace i (i=0,2,4,6) on the carrier k (k=0,1, . . . 499) is given by Y_{i,k} and the corresponding reference symbol (from QPSK modulation) is generated at the receiver from the scrambling operation be given by S_{i,k}=[b₂ₖ₊₁ b₂ₖ]. The removal of the modulation on the pilot subcarriers is performed as a rotation operation (by 0, 90, 180 or 270 degrees) followed by a multiplication by (1−j). The amount of rotation is determined by the reference symbol S_{i,k}. The rotation operation is followed by addition and subtraction of the real and imaginary components. The table for rotation of Y_{i,k} depending on the scrambler output bits (b₂ₖ₊₁ b₂ₖ) is given below in Table I, which is based on the gray mapping of bits to the QPSK constellation symbols.

TABLE I
Angle of rotation as a function of bits from scrambler.

| (b₂ₖ₊₁ b₂ₖ) (from scrambler) | Angle of rotation (degrees) |
|---|---|
| 00 | 0 |
| 01 | 90 |
| 11 | 180 |
| 10 | 270 |

At this point, it is noted that Y_{i,0} in i^{th} interlace buffer starts at the memory location 262. Hence, the 500 pilot observations are obtained in sequence by starting at 262, going through 511 and wrapping around to 0 and then through 249. Note that the memory locations 250 through 261 correspond to the guard carriers, and in this implementation they are set equal to zero. The interlace zero for FTA follows the conventions for data, i.e., pilots are written from location 262 to 511, location 0 (corresponding to DC) is skipped and is zeroed out, while locations 1 through 250 are populated. Guard carriers reside in locations 251 to 261 at this point.

Referring next to FIG. 10B, the L-tap channel impulse response from the IDFT unit 918 is shown for one embodiment. The impulse response shows the cyclic shift in the channel estimate. Each of the L taps is associated with a complex channel gain at that tap delay. The channel impulse response may be cyclically shifted, which means that the tail portion of the channel impulse response may wrap around and appear in the early portion of the output from IDFT unit 918.

Referring back to FIG. 9, a symbol timing searcher 920 may determine the symbol timing by detecting the beginning of the channel energy shown in FIG. 10B. The fixed point functionality of the symbol timing searcher 920 is divided into two subsections: a block for channel location and a block for fine timing correction. This detection of the beginning of the channel energy, also known as “first arriving path”, or FAP, may be achieved by sliding a “detection” window 1016 of length N_{W} across the channel impulse response, as indicated in FIG. 10B. The detection window size may be determined as described below. At each window starting position, the energy of all taps falling within the detection window is computed to find the accumulated energy shown as a curve in FIG. 10C.

With reference to FIG. 10C, a plot of the accumulated energy at different window starting positions is shown for one embodiment. The detection window is shifted to the right circularly so that after the right edge of the detection window reaches the last tap at index N_{C}, the window wraps around to the first tap at index 1. Energy is thus collected for the same number of channel taps for each detection window starting position.

The detection window size N_{W} may be selected based on the expected delay spread of the system. The delay spread at a wireless receiver is the time difference between the earliest and latest arriving signal components at the wireless receiver. The delay spread of the system is the largest delay spread among all wireless receivers in the system. If the detection window size is equal to or larger than the delay spread of the system, then the detection window, when properly aligned, would capture all of the energy of the channel impulse response. The detection window size N_{W} may also be selected in one embodiment to be no more than half of N_{C} (or N_{W}≦N_{C}/2) to avoid ambiguity in the detection of the beginning of the channel impulse response. Thus, as long as N_{C} is chosen to be longer or equal to the maximum expected channel delay spread, FTA can detect OFDM symbol timing without any ambiguity, regardless of the channel realization.

Referring next to FIG. 10D, an example of the negative derivative of the accumulated energy curve is shown. The beginning of the channel impulse response or FAP may be detected by (1) determining the peak energy among all of the detection window 1016 starting positions as shown in the accumulated energy curve of FIG. 10C, and (2) identifying the rightmost detection window 1016 starting position with the peak energy, if multiple window starting positions have the same or similar peak energies. A score could be derived from a weighted sum of the tap energy in the detection window 1016 and a finite difference from a maximum of the accumulated energy curve. Maximizing this score effectively finds a trailing edge of the accumulated energy curve's maximum region. The energies for different window starting positions may also be averaged or filtered to obtain a more accurate estimate of the beginning of the channel impulse response in a noisy channel. In any case, the beginning of the channel impulse response is denoted as FAP in FIG. 10D. Fine symbol timing corrections may be uniquely computed once the beginning of the channel impulse response T_{B} is determined. These corrections may be designed so as to bring the FAP location, or position T_{B} in FIG. 10B, close to position zero, or any other desired position, of the channel estimate during next OFDM symbol.

In a different embodiment, fine timing corrections may depend on both the FAP location, as well as the estimated delay spread of the channel, D. This delay spread, D, can be determined by finding both the leading and trailing edges of the accumulated energy curve. Similar to finding the trailing edge, the leading edge can be found by scoring a weighted sum of the accumulated energy and its positive finite difference. In a different embodiment, the fine timing searcher first finds the place T_{M} where the maximum accumulated energy occurs, and stores this maximum value E_{M}. Next, accumulated energy curve to the left and to the right of T_{M} is examined in an effort to locate positions where the accumulated energy drops below the value (1−b) E_{M}, for some pre-determined value b, less than one. In other words, the leading edge and the trailing edge of the accumulated energy curve is defined where the accumulated energy falls some percentage (e.g., 5% or 3%) away of its maximum over the detection window 1016. The percentage defines a band around a maximum of the accumulated energy position. Entering the band defines the leading edge of the flat portion in the band, T_{L}, while leaving the band defines the trailing edge of the flat portion in the band, T_{T}. The trailing edge coincides with the position of the first arriving path, while the leading edge is equal to the last arriving path minus N_{W}. The difference between the leading edge and the trailing edge is equal to N_{W} minus the delay spread, D. Therefore, delay spread D can be computed as D=N_{W}−T_{T}−T_{L}. Once D has been computed, fine timing corrections may be determined so that the channel content remains centered within the cyclic prefix area in the channel estimate during the next OFDM symbol.

Referring back to FIG. 10A, the fine symbol timing is indicative of the start of the received OFDM symbol. The fine symbol timing Ts may be used to accurately and properly place a DFT collection window for each subsequently received OFDM symbol (i.e., all subsequent OFDM symbols that carry data and FDM pilots). The DFT collection window indicates the specific N input samples (from among N+C input samples) to collect for each received OFDM symbol. The N input samples within the DFT collection window are then transformed with an N-point DFT to obtain N received data/pilot symbols for the received OFDM symbol. Accurate placement of the DFT collection window for each received OFDM symbol helps avoid (1) inter-symbol interference (ISI) from a preceding or next OFDM symbol, (2) degradation in channel estimation (e.g., improper DFT collection window placement may result in an erroneous channel estimate), (3) errors in processes that rely on the cyclic prefix (e.g., frequency tracking loop, and so on), and (4) other deleterious effects. The pilot-2 OFDM symbol may also be used to obtain a more accurate frequency error estimate by exploiting the periodic nature of TDM pilot 2.

The channel impulse response from IDFT unit 918 may also be used to derive a frequency response estimate for the communication channel between base station 10 and wireless receiver 150. A unit 922 receives the L-tap channel impulse response, circularly shifts the channel impulse response so that the beginning of the channel impulse response is at index 1, inserts an appropriate number of zeros after the circularly-shifted channel impulse response, and provides an N-tap channel impulse response. A DFT unit 924 then performs an N-point DFT on the N-tap channel impulse response and provides the frequency response estimate, which is composed of N complex channel gains for the N total subbands. OFDM demodulator 160 may use the frequency response estimate for detection of received data symbols in subsequent OFDM symbols. In other embodiments, this initial channel estimate may also be derived in some other manner.

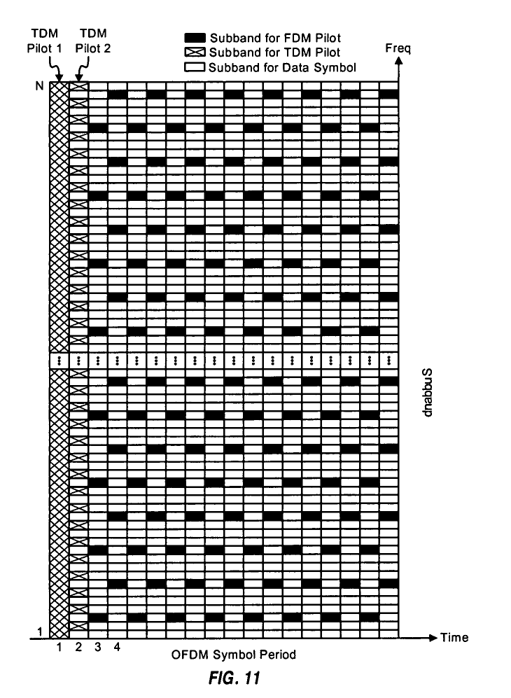

With reference to FIG. 11, an embodiment of a pilot transmission scheme with a combination of TDM and FDM pilots is shown. Base station 110 may transmit TDM pilots 1 and 2 in each super-frame to facilitate initial acquisition by the wireless receivers. The overhead for the TDM pilots is two OFDM symbols, which may be small compared to the size of the super-frame. The base station may also transmit an FDM pilot in all, most, or some of the remaining OFDM symbols in each super-frame. For the embodiment shown in FIG. 11, the FDM pilot is sent on alternating interlaces such that pilot symbols are sent on one interlace in even-numbered symbol periods and on another interlace in odd-numbered symbol periods. Each interlace contains a sufficient number of subbands to support channel estimation and possibly frequency and time tracking by the wireless receivers. In general, any number of interlaces may be used for the FDM pilot.

A wireless receiver may use TDM pilots 1 and 2 for initial synchronization, e.g., super-frame synchronization, frequency offset estimation, and fine symbol timing acquisition (for proper placement of the DFT collection window for subsequent OFDM symbols). The wireless receiver may perform initial synchronization, for example, when accessing a base station for the first time, when receiving or requesting data for the first time or after a long period of inactivity, when first powered on, and so on.

The wireless receiver may perform delayed correlation of the pilot-1 sequences to detect for the presence of a pilot-1 OFDM symbol and thus the start of a super-frame, as described above. Thereafter, the wireless receiver may use the pilot-1 sequences to estimate the frequency error in the pilot-1 OFDM symbol and to correct for this frequency error prior to receiving the pilot-2 OFDM symbol. The pilot-1 OFDM symbol allows for estimation of a larger frequency error and for more reliable placement of the sample window 1012 for the next pilot-2 OFDM symbol than conventional methods that use the cyclic prefix structure of the data OFDM symbols. The pilot-1 OFDM symbol can thus provide improved performance for a terrestrial radio channel with a large multi-path delay spread.

The wireless receiver may use the pilot-2 OFDM symbol to obtain fine symbol timing to more accurately place the DFT collection window for subsequent received OFDM symbols. The DFT collection window is the portion of the time-domain signal that captures the needed information used in decoding the data sent of a particular OFDM signal. The wireless receiver may also use the pilot-2 OFDM symbol for channel estimation and frequency error estimation. The pilot-2 OFDM symbol allows for fast and accurate determination of the fine symbol timing and proper placement of the DFT collection window.

The wireless receiver may use the FDM pilot for channel estimation and time tracking and possibly for frequency tracking. The wireless receiver may obtain an initial channel estimate based on the pilot-2 OFDM symbol, as described above. The wireless receiver may use the FDM pilot to obtain more channel estimates, particularly if the FDM pilot is transmitted across the super-frame, as shown in FIG. 11. The wireless receiver may also use the FDM pilots to update the frequency tracking loop that can correct for frequency error in the received OFDM symbols. The wireless receiver may further use the FDM pilots, and thus obtained channel estimates, to update a time tracking loop that can account for timing drift in the input samples (e.g., due to changes in the channel impulse response of the communication channel).

Channel Location and FAP Detection Algorithm

The output of the IFFT block 918 can be thought of a time-domain channel estimate that is 2048 taps long and possibly cyclically-shifted by the amount T_{B} as depicted in FIG. 10B. A task of the algorithm for channel location detection is to determine the amount of this cyclic shift T_{B}. This can be achieved through a combination of the accumulated energy within a sliding detection window and the negative difference calculation illustrated in FIG. 10D. This version of the channel location detection algorithm is also known as the first arriving path or FAP detection, since the described metric is designed to peak at the location of the FAP. In other embodiments, channel location detection may be performed using an alternative algorithm where both FAP and LAP locations are determined using the percentage method for detecting the edges of the flat zone as described previously. For simplicity, only the implementation of the FAP detection algorithm is described in detail in the following. N_{C} and N_{W} are defined as the lengths of the channel estimate sample window 1012 and the sliding energy detection window 1016, respectively. In order to avoid ambiguities in FAP detection in general, this embodiment satisfies the relationship N_{W}=N_{C}/2. In the IFFT block 918, this is achieved by having N_{C}=2048 and N_{W}=1024. These values are chosen under the assumption that the maximum delay spread does not exceed 1024 taps (or about 185 μs in one embodiment), the total channel energy can be captured in a sliding detection window 1016 of length equal to half the length of the channel estimate sample window 1012.

In the absence of noise, the maximum energy inside the window is reached when the (window starting position+N_{W}) modulo N_{C} is greater than the position of the last channel tap, and it stays at the maximum until the window starting position moves beyond the FAP. Therefore, detecting FAP simply amounts to detecting the trailing edge of a flat zone near the maximum of the accumulated energy curve shown in FIG. 10C. This can be achieved by combining the accumulated energy measurement within the detection window with the negative finite difference. The energy measurement is defined as Eₙ and the finite negative difference of order N_{D}, namely Dₙ by:

$${E}_{n} = {\sum }_{i = n}^{n + {N}_{w} - 1} {\vert h ( i ) \vert}^{2} , \\ and$$

$${D}_{n} = {\sum }_{i = {N}_{D}}^{2 {N}_{D} - 1} {E}_{n - i} - {\sum }_{i = 0}^{{N}_{D} - 1} {E}_{n - i} ,$$

where 0≦n≦N_{C}−1 denotes the beginning of the detection window, h(n) is the channel estimate, and the window “wraps around,” in the sense that the limits and the indexes in above summations should be taken modulo N_{C}. The location of the FAP is then roughly determined as the index n that maximizes the score. In other words, let:
Sₙ=α·E_{n-N}_{_{D}}+(1−α)·Dₙ, and n* =arg max[Sₙ], 2N_{D}−1≦n≦N_{C}+2N_{D}−1. (2)
Then the FAP position is found as
FAP=(n*−N_{D})mod N_{C}. (3)

In the algorithm outlined above, the free, adjustable parameters are α and N_{D}. The values N_{D} and α are kept programmable and different combinations of (N_{D}, α) pairs lead to different levels of importance the algorithm places on detecting the weak leading taps of the channel impulse response. Namely, embodiments with low values of N_{D} and high values of α typically detect FAPs which are small in magnitude. However, larger values of N_{D} lead to more noise averaging in making FAP decisions. The values used in one embodiment of fine timing acquisition are N_{D}=5 and α=0.9375.

FAP Detection Implementation

One thing specific to the implementation of FAP detection in the FTA mode is a stringent timeline for computation, which take places before the start of the next symbol. The time for computation (e.g., 300-400 microseconds in one embodiment) completes before the next OFDM overhead symbol 216 is received as shown in FIG. 10A. For this reason, the computation of the initial windowed energy measurements in Equation (1) is combined with the last stages of the FFT block 918 in this embodiment.

The FFT and IFFT implementation for the fine timing acquisition is optimized to meet a stringent timeline as follows:
1. The FFT architecture is used to allow for computation of the first stage of FFT processing in parallel with incoming data. One example FFT architecture is described in U.S. application Ser. No. 10/775,719, filed Feb. 9, 2004, which is incorporated by reference herein for all purposes. The FFT implementation is chosen to match the number of subbands per interlace (N_{I}). For example if pilot-2 uses N_{I}=512 and 4 interlaces, then the FFT implementation is chosen to be a cascade of 4×512 FFTs and the 4-point FFT is computed as the samples are received, with no extra latency.
2. The 512 point FFT is computed for interlaces in a specific order optimized for speed. For example, if the TDM pilot 2 is transmitted on the even subcarriers, the FFT is performed in the following order 6,4,2 and 0.
3. The pilot demodulation is performed on an interlace by interlace basis.
4. Once the pilot demodulation is done, the 2048 point IFFT is computed. This is performed in 3 steps for this embodiment.
   a. The interlaces 6,4,2 and 0 are processed by a 512 point IFFT.
   b. The twiddle multiplication is applied only for interlaces 6,4 and 2. Interlace 0 does not use any twiddle multiplication. Therefore, the IFFT for interlace 0 can happen in parallel with the twiddle computation for the other interlaces, saving time.
   c. 4-point IFFT to combine the 512 point IFFT outputs.
5. The 4-point IFFT stage is combined with the initialization of the FAP detection algorithm. The 4-point IFFT provides the following samples:
h(n), h(n+N_{W}/2), h(n+N_{W}), h(n+3N_{W}/2), for 0≦N_{W}/2−1.

Notice that in order to compute the windowed energy in Equation (1) from position 0, namely E₀, we wait until all N_{W}/2 4-point IFFTs have been completed. However, at the same time we have enough data to compute E_{N}_{_{W}}; thus these two sliding window accumulators can be computed in parallel. Also, consider the energy update step for the two accumulators:
Eₙ₊₁=Eₙ−{|h(n)|²−|h(n+N_{W})|²}=Eₙ−d(n), for 0≦n≦N_{W}−2 and
E_{n+N}_{_{W}}₊₁=E_{n+N}_{W}+{|h(n)|²−|h(n+N_{W})|²}=E_{n+N}_{_{W}}+d(n), for 0≦n≦N_{W}−2. (4)

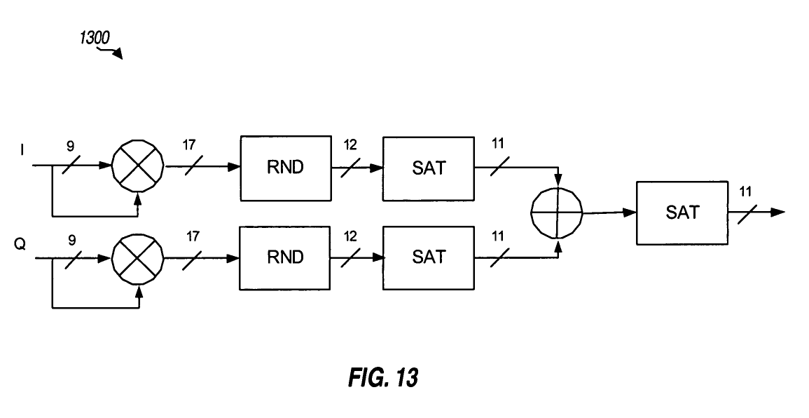

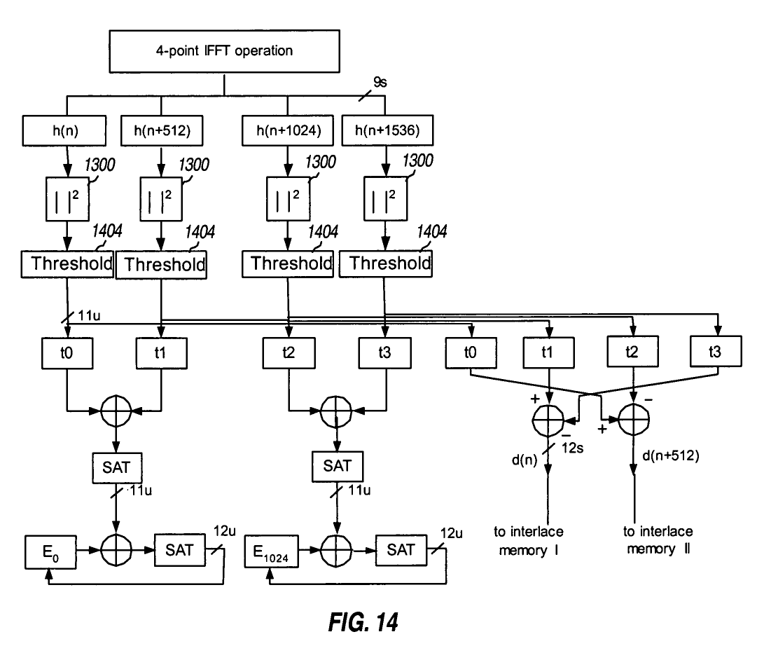

Since the same correction factor is used to update both accumulators, these values d(n) are stored for future use. The first phase of the FAP detection includes computing E₀, E_{N}_{_{W}} and values d(n), for 0≦n≦N_{W}−1. First phase is carried on in parallel with N_{W}/2 4-point IFFTs and thus may use as much time. An embodiment of this computation is shown in FIG. 14. Each norm operation 1408 is the same and results in 11 unsigned bits. The block diagram for the norm operation 1408 is shown in FIG. 13.

Channel estimates obtained using TDM pilot 2 can be “noisy” in low SNR scenarios. Sometimes, noise can appear as artificial channel content, and timing corrections during FTA could erroneously take this artificial content into account when analyzing the channel estimate. Sometimes, calculated symbol timing based on the noise can result in poorer performance. In one embodiment, the channel tap energies are compared to a pre-determined threshold to remove the tap energies if below the threshold. After the norm operation 1408, some embodiments include a threshold block 1404 that removes the tap energies. In one embodiment, the threshold limit can be chosen as K times the expected variance of the noise, under the assumption that the input SNR is some pre-determined lower value P. By choosing P and K appropriately, one can adjust the probability that an artificial tap will appear in a TDM 2 channel estimate due to noise at input SNRs P and higher. In one example, K can be chosen as 12 and P as −2 dB. In any case, this threshold is kept programmable, and if set to zero, effectively no thresholding takes place in block 1404.

After the completion of the first phase, the second phase is performed, where the values of finite difference Dₙ and score Sₙ are initialized as used in Equation (2). Several boundary values of Eₙ are stored. The second phase is described before providing the sequence of operations. According to Equation (1), the first value of the finite difference that is computed is D_{2N}_{_{D}}₋₁, and for its computation, the energy values E₀ to E_{2N}_{_{D}}₋₁ are found. These energy values are computed using the recursion Equation (4). Throughout the process other things are still computed in parallel, along the two tracks offset by N_{W}; in other words, the energy values E_{N}_{_{W}} to E_{N}_{_{W}}_{+2N}_{_{D}}₋₁ are computed and used to initialize D_{N}_{_{W}}_{+2N}_{_{D}}₋₁. At the same time, the energy values E₀ to E_{2N}_{_{D}}₋₂ as well as E_{N}_{_{W}} to E_{N}_{_{W}}_{+2N}_{_{D}}₋₂ are stored and they will be used for computing the boundary values of finite differences and scores. The sequence of operations in the second phase is as follows for one embodiment:
1) Initialize D_{2N}_{_{D}}₋₁=0, D_{N}_{_{W}}_{+2N}_{_{D}}₋₁=0, S*=0. Finite differences are 14-bit signed numbers with scaling 2⁵, and the maximum score S* is a 12-bit unsigned number (scaling 2⁴). Update D_{2N}_{_{D}}₋₁=E₀, and D_{N}_{_{W}}_{+2N}_{_{D}}₋₁=E_{N}_{_{W}}, keeping the same precision. Store E₀ and E_{N}_{_{W}} in memory.
2) For n=1; n≦2N_{D}−1; n++, do the following:
   Update the values Eₙ and E_{n+N}_{_{W}} according to Equation (4); after each addition/subtraction, saturate the result back to 12 unsigned bits (results are guaranteed to be positive).
   If n<N_{D} update differences as D_{2N}_{_{D}}₋₁=D_{2N}_{_{D}}₋₁+Eₙ, and D_{N}_{_{W+2N}}_{_{D}}₋₁=D_{N}_{_{W}}_{+2N}_{_{D}}₋₁+E_{n+N}_{_{W}}, otherwise as D_{2N}_{_{D}}₋₁=D_{2N}_{_{D}}₋₁−Eₙ, and D_{N}_{_{W}}_{+2N}_{_{D}}₋₁=D_{N}_{_{W}}_{+2N}_{_{D}}₋₁−E_{n+N}_{_{W}}; saturate back to 14 signed bits.
   Store Eₙ and E_{n+N}_{_{W}} in memory; they are used at the end of the last phase of FAP detection.
   3) Initialize two running buffers:
      E_{BUFF1}=[E₀ E₁ . . . E_{2N}_{_{D}}₋₁], E_{BUFF2}[E_{N}_{_{W}} E_{N}_{_{W}}₊₁ . . . E_{N}_{_{W}}_{+2N}_{_{D}}₋₁].

Note that E_{2N}_{_{D}}₋₁ and E_{N}_{_{W}}_{+2N}_{_{D}}₋₁ are not used for computing the boundary values of Dₙ, however this embodiment stores them as well, which may result in fewer exceptions for the hardware. Completion of phase two marks the initialization of the block for FAP detection. This detection takes place in phase three, and is described next.

To summarize, at this point the following variables are to be initialized:
Running buffers E_{BUFF1} and E_{BUFF2} of 2N_{D} elements each.
Best score S*=0.
Energy values E₀, E₁, . . . E_{2N}_{_{D}}₋₁ as well as E_{N}_{_{W}}, E_{N}_{_{W}}₊₁, . . . E_{N}_{_{W}}_{+2N}_{_{D}}₋₁ stored for future use.
Programmable parameter α used in Equation (2) and initialized to a 5-bit unsigned value.
Values d(n), for 0≦n≦N_{W}−1 stored in memory.
Also, initialize E_{TEMP1}=E_{2N}_{_{D}}₋₁, E_{TEMP2}=E_{N}_{_{W}}_{+2N}_{_{D}}₋₁, D_{TEMP1}=D_{2N}_{_{D}}₋₁ and D_{TEMP2}=D_{N}_{_{W}}_{+2N}_{_{D}}₋₁.

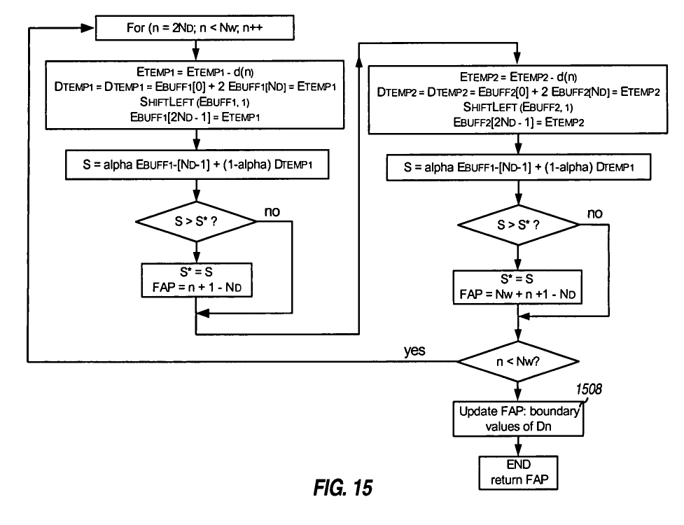

Phase three of the FAP detection algorithm can be summarized as shown in the flow chart of FIG. 15, where it is demonstrated that the FAP positions can take values in the intervals:
N_{D}+1≦n≦N_{W}−N_{D}, and N_{W}+N_{D}+1≦n≦N_{C}−N_{D}.
The missing points are located at the boundaries of the two starting window positions, i.e., around position 0 and position N_{W}. These extreme cases are handled by step 1508 called “Update FAP,” and are dependent on the stored energy values. In one embodiment, the sequence of operations for step 1508 is as follows.

For n=1; n≦2N_{D}−1; n++, do the following:
1) Update D_{TEMP1}=D_{TEMP1}−E_{BUFF1}[0]+2E_{BUFF1}[N_{D}]−E_{n+N}_{_{W}}, and D_{TEMP2}=D_{TEMP2}−E_{BUFF2}[0]+2E_{BUFF2}[N_{D}]−Eₙ.
2) Shift E_{BUFF1} and E_{BUFF2} by one element to the left, adding E_{n+N}_{_{w}} and Eₙ to their right, respectively.
3) S=α·E_{BUFF1}[N_{D}−1]+(1−α)·D_{TEMP1}; if S>S*, update S*=S and FAP=(n+N_{W}−N_{D}+1) mod N_{W}.
4) S=α·E_{BUFF2}[N_{D}−1]+(1−α)·D_{TEMP2}; if S>S*, update S*=S and FAP=N_{W}+(n+N_{W}−N_{D}+1)mod N_{W}.

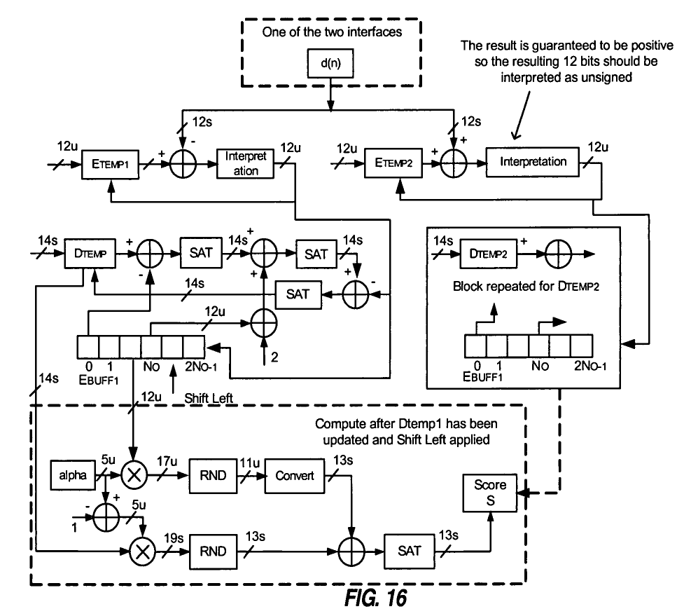

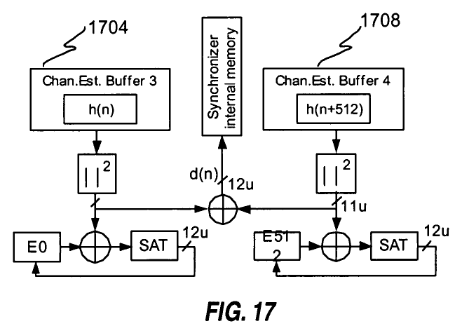

At this point in the processing, the FTA algorithm has completed phase three, the FAP has been detected, and the FAP position has been stored in variable FAP. The last stage of the FTA algorithm is to compute the fine timing correction based on this information. Before we describe this phase, we provide additional details on the implementation of phase three described above. To this end, consider FIG. 16, which presents a fixed point implementation of the update step characteristic for phase three. It is interpreted together with the flow chart of FIG. 15, since flow chart shows the sequence of operations. Once the score, S, has been computed for both halves of the channel response (Note: FIG. 16 only shows the first half), the values are compared to the present maximum score value S* and, if necessary, the maximum score value and the FAP position are updated as described above. The final output of the FAP detection algorithm is an integer FAP which can take values between 0 and N_{C}−1=2047. Below, we describe how this integer value is used to compute the fine offset, and what is the impact on the OFDM sample counter.

Fine Timing Offset Calculation and Correction

The integer value representing the location of the FAP, T_{B}, of the wrapped-around channel estimate as in FIG. 10C is translated into the fine timing offset that is the ultimate result of the FTA algorithm. This step is complicated by the fact that in sampling TDM pilot-2 symbol we introduced a deliberate delay of 1024−K samples, where K=256 in the embodiment described above, and the fact that the coarse offset provided by coarse acquisition might be off by more than ±512 samples. This embodiment of the algorithm is as follows:
If FAP>512,
   offset=FAP+512−2048+17−B_{OFF};
Else,
   offset=FAP+512+17−B_{OFF};

Here, the factor 17 corresponds to the window of 17 samples inserted between two OFDM symbols in this embodiment, and it is understood that the corresponding factor may vary in different embodiments. Next, the factor B_{OFF} is a programmable parameter responsible for inserting a deterministic delay in the perceived symbol boundaries, or, equivalently, for introducing a bias in FAP placement for future OFDM symbols. This parameter is usually chosen as a positive value, since it can be shown that making a negative error in the symbol boundary estimation (called “late symbol sampling”) leads to worse performance. In one embodiment, the value of B_{OFF} is chosen to be 127, but other embodiments could use other values.

The first option in the conditional tends happens more often, assuming that the coarse acquisition error was less then ±512 samples. The FTA algorithm can, in principle, handle coarse timing errors of up to ±1024 samples, however, if the initial acquisition algorithm was late by more than 512 samples, there might not be enough time left to compute the correct offset and apply it before the beginning of the first symbol in the Overhead OFDM symbols 216 shown in FIGS. 2A and 2B.

The integer value offset calculated above is used to apply fine timing correction by modifying the OFDM sample counter content before the beginning of the next OFDM symbol as described above. The counter rolls over once the value of 4625 has been reached, but updating the current value in the counter effectively changes the point of this roll-over. In one embodiment, the value offset calculated above can be first limited to ±512 before getting applied, in order to facilitate an easier transition of the frequency tracking block.

The final stage in the FTA algorithm is using the channel estimate obtained as above in order to initialize the time filter in the channel estimation block. This initialization helps in correct demodulation of the next symbol. The channel estimation initialization is described next.

Bootstrapping Channel Estimation

The algorithm for bootstrapping the channel estimation for the channel estimator 730 is described below. One aim of the channel estimator 730 is to provide a starting point for a channel estimation time filter. The time filter works on three consecutive channel estimates, h(n−1), h(n), h(n+1), 512-samples long, representing the past present and future. All three locations are initialized to all-zeros. As the last stage of the FTA is completed, the location corresponding to the present, namely h(n) is initialized with the 512-tap channel estimate derived from the 1024-long estimate computed above [we will refer to this impulse response as ĥ(n)]. The modifications to ĥ(n) are three-fold:
1) ĥ(n) is a cyclically-shifted version of the properly aligned 1024-long channel estimate that would have been obtained if the symbol timing was correct. This offset, FAP, is calculated in phase three of FAP detection above. Therefore, when bootstrapping the channel estimation, we consider the channel estimate h₁₀₂₄(n) obtained by cyclic-shifting the estimate at hand, ĥ(n). In other words:
   h₁₀₂₄(n)=ĥ[(n+FAP)mod N_{C}], 0≦n≦N_{W}−1. (5)
2) h₁₀₂₄(n) is converted into a 512-long channel estimate which would be obtained during the TDM pilot 2 if it was replaced by a data symbol with 512 pilot tones on interlace 6. One reason for this operation lies in the time filtering operation of the channel estimation block 730. Namely, the channel estimates used for data demodulation are obtained in a “time filtering” unit of the channel estimation block which combines the estimates obtained by FDM pilots in three consecutive OFDM symbols in one embodiment. For this block, the FDM pilots are staggered in interlaces across consecutive OFDM symbols as shown in FIG. 11. Notice that FDM pilots in the first symbol after TDM pilot 2 lie on interlace 2, so the corresponding FDM pilots would have been placed on interlace 6 in TDM pilot 2, had it been a normal OFDM symbol. Therefore, using TDM pilot 2 to carefully bootstrap the channel estimation block allows it to fake the presence of a normal symbol in the place of TDM pilot 2, and consequently speed-up the generation of the first channel estimate which can be used for data demodulation. This conversion to a 512-long channel observation is achieved by aliasing the second half of h₁₀₂₄(n) atop of its first half, in other words, for 0≦n<N_{W}/2:

$$\begin{matrix}\hat{y} ( n ) = {h}_{1024} ( n ) + {h}_{1024} ( n + {N}_{W} / 2 ) \cdot {ⅇ}^{- j \frac{2 π \cdot 6}{8}} \\ = {h}_{1024} ( n ) + j \cdot {h}_{1024} ( n + {N}_{W} / 2 ) .\end{matrix} \qquad ( 6 )$$
3) ŷ(n), as obtained in Equation (6), is scaled up by a factor \sqrt{2} with respect to the channel estimates. Therefore, the last step is to scale the channel estimate by the appropriate factor:
   y(n)=ŷ(n)/\sqrt{2}. (7)
   Data Mode Time Tracking

In data mode time tracking (DMTT), the problem is similar in that timing corrections can be done based on channel estimates, only that the channel estimates are now obtained using FDM pilots. The algorithm for finding timing corrections (or timing offsets as mentioned above) based on channel estimates can be rather similar in one embodiment). In this case most of the hardware used for FTA can be re-used for DMTT purposes.

Channel estimates based on TDM pilot 2 in FTA mode are longer in one embodiment (e.g., length 2048 taps) than channel estimates in DMTT (e.g., length 1024 taps). Longer channel estimates may help in resolving ambiguities in OFDM symbol timing, when channel is longer than 512 taps, but shorter than 1024 taps, for example. Any channel response longer than 512 taps can potentially create a problem for some DMTT algorithms, since DMTT is performed on channel estimates of length 1024. However, TDM pilot 2-based channel estimates in FTA mode are twice as long in one embodiment to allow uniquely resolving the location of the channels up to length 1024 taps.

With TDM pilot 2 transmitted at least in every super-frame, TDM pilot 2 can be acquired periodically once in N super-frames by the receiver to resolve any potential timing ambiguities in some embodiments. N can be programmable and might be changed based upon delay spread or other factors. The FTA process would be performed on each Nth super-frame to apply corrections to the ongoing DMTT process.

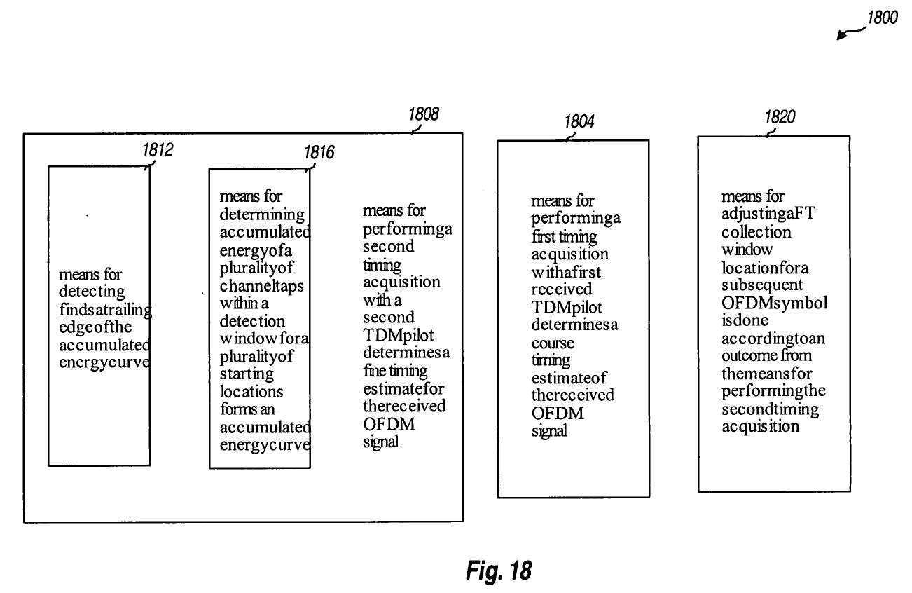

Referring next to FIG. 18, an OFDM system 1800 for synchronizing timing of a receiver to a received OFDM signal is disclosed. The OFDM system includes means for performing a first timing acquisition 1804, means for performing a second timing acquisition 1808 and means for adjusting a DFT collection window location 1820. The means for performing a first timing acquisition with a first received TDM pilot determines a course timing estimate of the received OFDM signal. The means for performing a second timing acquisition with a second TDM pilot determines a fine timing estimate for the received OFDM signal. The first TDM pilot is received before the second TDM pilot and the fine timing estimate is a refinement of the course timing estimate. The means for performing the second timing acquisition includes means for determining 1816 and means for detecting 1812. The means for determining accumulated energy of a plurality of channel taps within a detection window for a plurality of starting locations forms an accumulated energy curve. The means for detecting finds a trailing edge of the accumulated energy curve. The means for adjusting a FT collection window location for a subsequent OFDM symbol is done according to an outcome from the means for performing the second timing acquisition.

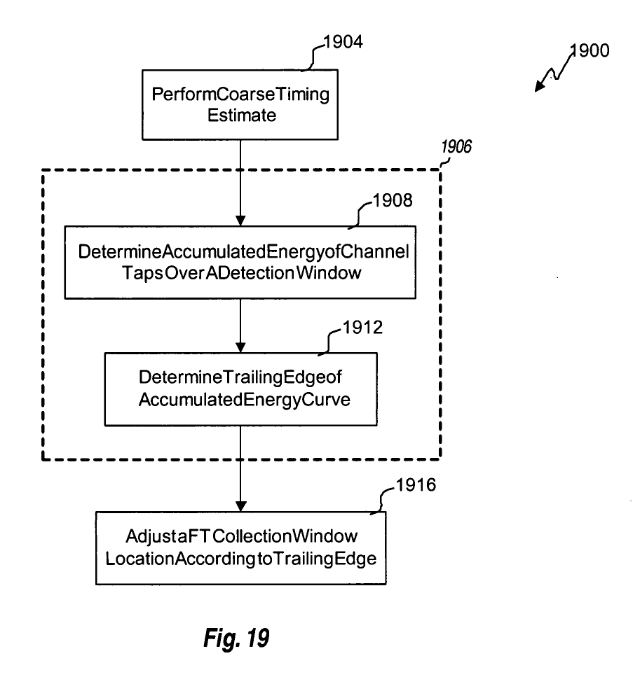

With reference to FIG. 19, an embodiment of a process 1900 for synchronizing timing of a receiver to a received OFDM signal is disclosed. A first timing acquisition is performed with a first received TDM pilot to determine a course timing estimate of the received OFDM signal in block 1904. A second timing acquisition is performed with a second TDM pilot in block 1906 to determine a fine timing estimate for a OFDM symbol of the received OFDM signal. In the second timing acquisition block 1906, the accumulated energy of channel taps over a detection window is determined in block 1908 and a trailing edge of the accumulated energy curve is detected in block 1912. In block 1916, a FT collection window location for subsequent OFDM symbols is adjusted according to the information about the trailing and/or leading edge information.

The synchronization techniques described herein may be implemented by various means. For example, these techniques may be implemented in hardware, software, or a combination thereof. For a hardware implementation, the processing units at a base station used to support synchronization (e.g., TX data and pilot processor 120) may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. The processing units at a wireless receiver used to perform synchronization (e.g., SCEU 180) may also be implemented within one or more ASICs, DSPs, and so on.

For a software implementation, the synchronization techniques may be implemented with modules (e.g., procedures, functions, and so on) that perform the functions described herein. The software codes may be stored in a memory unit (e.g., memory unit 192 in FIG. 1) and executed by a processor (e.g., controller 190). The memory unit may be implemented within the processor or external to the processor.

While the principles of the disclosure have been described above in connection with specific apparatuses and methods, it is to be clearly understood that this description is made only by way of example and not as limitation on the scope of the invention.

What is claimed is:

1. A method for synchronizing timing of a receiver to a received orthogonal frequency division multiplexing (OFDM) signal, the method comprising steps of:
performing a first timing acquisition with a first received time division multiplexed (TDM) pilot to determine a course timing estimate of the received OFDM signal;
performing a second timing acquisition with a second TDM pilot to determine a fine timing estimate of the received OFDM signal, wherein the performing the second timing acquisition step comprises sub-steps of:
determining accumulated energy of a plurality of channel taps within a detection window for a plurality of starting locations to form an accumulated energy curve, and
detecting a trailing edge of the accumulated energy curve; and
adjusting a Fourier transform (FT) collection window location for a subsequent OFDM symbol according to the performing the second timing acquisition step.

2. The method for synchronizing timing of the receiver to the received OFDM signal as recited in claim 1, wherein the first TDM pilot is received before the second TDM pilot.

3. The method for synchronizing timing of the receiver to the received OFDM signal as recited in claim 1, wherein the fine timing estimate is a refinement of the course timing estimate.

4. The method for synchronizing timing of the receiver to the received OFDM signal as recited in claim 1, wherein the trailing edge is located using a weighted sum of the accumulated energy at a particular starting location of the plurality of starting locations and a negative finite difference of the accumulated energy curve at the particular starting location.

5. The method for synchronizing timing of the receiver to the received OFDM signal as recited in claim 1, wherein the detecting sub-step allows determining a first arriving path (FAP).

6. The method for synchronizing timing of the receiver to the received OFDM signal as recited in claim 1, wherein a leading edge and the trailing edge of a flat zone in the accumulated energy curve are both detected from the flat zone that is declared as a region within a certain percentage of energy from a maximum point in the accumulated energy curve.

7. The method for synchronizing timing of the receiver to the received OFDM signal as recited in claim 1, wherein at least one of the trailing edge or a leading edge of the accumulated energy curve is translated into a timing correction.

8. The method for synchronizing timing of the receiver to the received OFDM signal as recited in claim 7, wherein FAP is placed in relation to the trailing edge.

9. The method for synchronizing timing of the receiver to the received OFDM signal as recited in claim 1, wherein at least one of the trailing edge or a leading edge of the accumulated energy curve is translated into a timing correction by placing a location of a channel profile in relation to at least one of the trailing or leading edges.

10. The method for synchronizing timing of the receiver to the received OFDM signal as recited in claim 1, wherein each of the plurality of channel taps corresponds to a complex channel gain at a respective tap delay.

11. The method for synchronizing timing of the receiver to the received OFDM signal as recited in claim 1, wherein the step of performing a second timing acquisition is completed before the end of the second TDM pilot.

12. The method for synchronizing timing of the receiver to the received OFDM signal as recited in claim 1, wherein the determining sub-step and the detecting sub-step are performed, at least partially, co-incident in time for a particular channel tap of the plurality of channel taps.

13. The method for synchronizing timing of the receiver to the received OFDM signal as recited in claim 1, wherein the receiver is at least one of a wired receiver or a wireless receiver.

14. The method for synchronizing timing of the receiver to the received OFDM signal as recited in claim 1, further comprising a step of bootstrapping a channel estimation using a channel estimate obtained during the performing the second timing acquisition step.

15. The method for synchronizing timing of the receiver to the received OFDM signal as recited in claim 1, wherein the performing the second timing acquisition step further comprises a sub-step performing a Fourier transform over the FT collection window, wherein the FT collection window is twice a size of the detection window.

16. The method for synchronizing timing of the receiver to the received OFDM signal as recited in claim 1, wherein the accumulated energy curve is filtered, whereby spurious detection of the trailing edge is reduced.

17. The method for synchronizing timing of the receiver to the received OFDM signal as recited in claim 1, wherein the performing the second timing acquisition step further comprises a sub-step of thresholding each of the plurality of channel taps before the determining sub-step.

18. An OFDM system for synchronizing timing of a receiver to a received OFDM signal, the OFDM system comprising:
means for performing a first timing acquisition with a first received TDM pilot to determine a course timing estimate of the received OFDM signal;
means for performing a second timing acquisition with a second TDM pilot to determine a fine timing estimate of the received OFDM signal, wherein the means for performing the second timing acquisition comprises:
means for determining accumulated energy of a plurality of channel taps within a detection window for a plurality of starting locations to form an accumulated energy curve, and
means for detecting a trailing edge of the accumulated energy curve; and
means for adjusting a FT collection window location for a subsequent OFDM symbol according to an outcome from the means for performing the second timing acquisition.

19. The OFDM system for synchronizing timing of the receiver to the received OFDM signal as recited in claim 18, wherein the first TDM pilot is received before the second TDM pilot.

20. The OFDM system for synchronizing timing of the receiver to the received OFDM signal as recited in claim 18, wherein the fine timing estimate is a refinement of the course timing estimate.

21. The OFDM system for synchronizing timing of the receiver to the received OFDM signal as recited in claim 18, wherein the trailing edge is located using a weighted sum of the accumulated energy at a particular starting location of the plurality of starting locations and a negative finite difference of the accumulated energy curve at the particular starting location.

22. The OFDM system for synchronizing timing of the receiver to the received OFDM signal as recited in claim 18, wherein a leading edge and the trailing edge of a flat zone in the accumulated energy curve are both detected from the flat zone that is declared as a region within a certain percentage of energy from a maximum point in the accumulated energy curve.

23. The OFDM system for synchronizing timing of the receiver to the received OFDM signal as recited in claim 18, wherein each of the plurality of channel taps corresponds to a complex channel gain at a respective tap delay.

24. The OFDM system for synchronizing timing of the receiver to the received OFDM signal as recited in claim 18, wherein the second TDM pilot comprises a cyclic prefix and a plurality of identical pilot sequences.

25. The OFDM system for synchronizing timing of the receiver to the received OFDM signal as recited in claim 18, wherein the means for determining and the means for detecting are used, at least partially, co-incident in time for a particular channel tap of the plurality of channel taps.

26. The OFDM system for synchronizing timing of the receiver to the received OFDM signal as recited in claim 18, wherein the receiver is at least one of a wired receiver or a wireless receiver.

27. The OFDM system for synchronizing timing of the receiver to the received OFDM signal as recited in claim 18, wherein the accumulated energy curve is filtered, whereby spurious detection of the trailing edge is reduced.

28. A method for synchronizing timing of a receiver to a received signal, the method comprising steps of:
performing a first timing acquisition to determine a course timing estimate of the received signal;
performing a second timing acquisition with a TDM pilot to determine a fine timing estimate for a symbol of the received signal, wherein the performing the second timing acquisition step comprises sub-steps of:
determining accumulated energy of a plurality of channel taps within a detection window for a plurality of starting locations to form an accumulated energy curve,
detecting a trailing edge of the accumulated energy curve, and
the determining sub-step and the detecting sub-step are performed, at least partially, co-incident in time for a particular channel tap of the plurality of channel taps; and
adjusting a FT collection window location for a subsequent symbol according to the performing the second timing acquisition step.

29. The method for synchronizing timing of the receiver to the received signal as recited in claim 28, wherein the fine timing estimate is a refinement of the course timing estimate.

30. The method for synchronizing timing of the receiver to the received signal as recited in claim 28, wherein the trailing edge is located using a weighted sum of the accumulated energy at a particular starting location of the plurality of starting locations and a negative finite difference of the accumulated energy curve at the particular starting location.

31. The method for synchronizing timing of the receiver to the received signal as recited in claim 30, wherein the subsequent symbol is an OFDM symbol comprising:
a plurality of data symbols, and
a plurality of frequency division multiplexed (FDM) pilots.

32. The method for synchronizing timing of the receiver to the received signal as recited in claim 30, wherein a leading edge and the trailing edge of a flat zone in the accumulated energy curve are both detected from the flat zone that is declared as a region within a certain percentage of energy from a maximum point in the accumulated energy curve.

33. The method for synchronizing timing of the receiver to the received signal as recited in claim 28, wherein each of the plurality of channel taps corresponds to a complex channel gain at a respective tap delay.

34. The method for synchronizing timing of the receiver to the received signal as recited in claim 28, wherein the receiver is at least one of a wired receiver or a wireless receiver.

35. The method for synchronizing timing of the receiver to the received signal as recited in claim 28, wherein the accumulated energy curve is filtered, whereby spurious detection of the trailing edge is reduced.

36. A communication device for synchronizing timing of a receiver to a received signal, the communication device comprising:
a processor configured to:
cause performing a first timing acquisition with a first received time division multiplexed (TDM) pilot to determine a course timing estimate of the received OFDM signal;
cause performing a second timing acquisition with a second TDM pilot to determine a fine timing estimate of the received OFDM signal, wherein the performing the second timing acquisition step comprises sub-steps of:
determining accumulated energy of a plurality of channel taps within a detection window for a plurality of starting locations to form an accumulated energy curve, and
detecting a trailing edge of the accumulated energy curve; and
causing adjustment of a Fourier transform (FT) collection window location for a subsequent OFDM symbol according to the performing the second timing acquisition step; and
a memory coupled with the processor.

37. The communication device as recited in claim 36, wherein the first TDM pilot is received before the second TDM pilot.

38. The communication device as recited in claim 36, wherein the fine timing estimate is a refinement of the course timing estimate.
